(19) United States
(12) Patent Application Publication
(10) Pub. No.: US 2023/0090811 A1
(43) Pub. Date: Mar. 23, 2023

(54) INDUCTION-HEATING-TYPE ARTICLE AND DEVICE FOR GENERATING AEROSOL

(71) Applicant: KT&G CORPORATION, Daejeon (KR)

(72) Inventors: Jin Chul JUNG, Daejeon (KR); Jang Won SEO, Daejeon (KR); Min Seok JEONG, Daejeon (KR); Gyoung Min GO, Daejeon (KR); Hyung Jin BAE, Daejeon (KR); Chul Ho JANG, Daejeon (KR); Jong Seong JEONG, Daejeon (KR)

(73) Assignee: KT&G CORPORATION, Daejeon (KR)

(21) Appl. No.: 17/793,759

(22) PCT Filed: Sep. 14, 2021
(86) PCT No.: PCT/KR2021/012464

§ 371 Date: Jul. 19, 2022

(30) Foreign Application Priority Data
Oct. 23, 2020 (KR) 10-2020-0138093

(51) Int. Cl. A24F 40/465; H05B 6/10; A24D 1/20; A24F 40/20; A24F 40/57

(52) U.S. Cl. CPC A24F 40/465; H05B 6/105; A24D 1/20; A24F 40/20; A24F 40/57

(57) ABSTRACT

Provided herein are an induction heating-type aerosol-generating article and device with improved heating efficiency. The induction heating-type aerosol-generating article according to some embodiments of the present disclosure includes a medium portion which includes an aerosol-forming substrate, a susceptor element which forms a closed loop to wrap around at least a portion of the medium portion and which is configured to, due to induction heating being performed therein, heat at least a portion of the medium portion, and an outer wrapper which wraps around at least a portion of the susceptor element. In this case, since the susceptor element is embedded in the aerosol-generating article and directly transmits heat to the medium portion, and an induced current may smoothly flow through the formed closed loop, heating efficiency may be significantly improved.

### TECHNICAL FIELD

The present disclosure relates to an induction heating-type article and device for generating an aerosol, and more particularly, to an induction heating-type aerosol-generating article, which is capable of reducing power consumption through an improvement in heating efficiency and guaranteeing a flavor enhancing effect, and an induction heating-type aerosol generation device used along with the article.

### BACKGROUND ART

In recent years, demand for alternative methods that overcome the disadvantages of general cigarettes has increased. For example, demand for heating-type aerosol generation devices that electrically heat a cigarette to generate an aerosol has increased. Accordingly, active research has been carried out on heating-type aerosol generation devices.

Recently, devices that heat a cigarette by induction heating to generate an aerosol have been proposed. For example, a device that inductively heats an external susceptor, which is disposed in a form surrounding a cigarette accommodated therein, through an induction coil to generate an aerosol has been proposed. However, since the proposed device employs an indirect heating structure in which the susceptor is utilized as an intermediate medium to transmit heat to the cigarette, the heating efficiency is not good, and accordingly, a large amount of time and high power consumption are necessary to heat the cigarette to a target temperature.

### DISCLOSURE

### Technical Problem

Some embodiments of the present disclosure are directed to providing an induction heating-type aerosol-generating article with improved heating efficiency and an induction heating-type aerosol generation device used along with the article.

Objectives of the present disclosure are not limited to the above-mentioned objective, and other unmentioned objectives should be clearly understood by those of ordinary skill in the art to which the present disclosure pertains from the description below.

### Technical Solution

An induction heating-type aerosol-generating article according to some embodiments of the present disclosure includes a medium portion which includes an aerosol-forming substrate, a susceptor element which forms a closed loop to wrap around at least a portion of the medium portion and which is configured to, due to induction heating being performed therein, heat at least a portion of the medium portion, and an outer wrapper which wraps around at least a portion of the susceptor element.

In some embodiments, the susceptor element may be made of an inductively-heatable nonferrous metal material.

In some embodiments, the induction heating-type aerosol-generating article may further include an inner wrapper which is disposed between the susceptor element and the medium portion to wrap around at least a portion of the medium portion.

In some embodiments, a thickness of the susceptor element may be in a range of 6 μm to 30 μm.

In some embodiments, the susceptor element may be configured to wrap around an upstream portion of the medium portion such that an unheated region is formed in a downstream portion of the medium portion when the induction heating is performed.

In some embodiments, the medium portion may include a first segment which contains a tobacco material and a second segment which is disposed upstream of the first segment and contains a moisturizing material, the susceptor element may include a first susceptor element which wraps around the first segment and a second susceptor element which wraps around the second segment, such that the downstream portion is heated to a higher temperature than the upstream portion by the first susceptor element when the induction heating is performed.

An induction heating-type aerosol generation device according to some embodiments of the present disclosure includes a housing which forms an accommodation space for accommodating an aerosol-generating article and an inductor which inductively heats the aerosol-generating article accommodated in the accommodation space to generate an aerosol. Here, the aerosol-generating article may include a medium portion which includes an aerosol-forming substrate and a susceptor element which forms a closed loop to wrap around at least a portion of the medium portion, such that the aerosol may be generated as the susceptor element is inductively heated by the inductor.

In some embodiments, the induction heating-type aerosol generation device may not include the susceptor element inductively heated by the inductor.

In some embodiments, the induction heating-type aerosol generation device may further include a controller which controls an induction heating frequency applied to the inductor, the susceptor element may include a first susceptor element which wraps around a downstream portion of the medium portion and a second susceptor element which wraps around an upstream portion of the medium portion, the inductor may inductively heat the first susceptor element and the second susceptor element using the same induction heating frequency, and the first susceptor element may have a thickness different from a thickness of the second susceptor element.

In some embodiments, the induction heating-type aerosol generation device may further include a controller which controls an induction heating frequency applied to the inductor, the susceptor element may include a first susceptor element which wraps around a downstream portion of the medium portion and a second susceptor element which wraps around an upstream portion of the medium portion, the inductor may inductively heat the first susceptor element and the second susceptor element using the same induction heating frequency, and the first susceptor element may be made of a material different from a material of the second susceptor element.

In some embodiments, the induction heating-type aerosol generation device may further include a controller which controls an induction heating frequency applied to the inductor, the susceptor element may include a first susceptor element which wraps around a downstream portion of the medium portion and a second susceptor element which wraps around an upstream portion of the medium portion, and the inductor may include a first inductor which inductively heats the first susceptor element using a first induction heating frequency and a second inductor which inductively heats the second susceptor element using a second induction heating frequency different from the first induction heating frequency.

### Advantageous Effects

According to some embodiments of the present disclosure, an induction heating-type aerosol-generating article in which a susceptor element is embedded can be provided, and the susceptor element can be disposed in a form wrapping around a medium portion. In this case, since heat generated in the susceptor element due to induction heating can be directly transmitted to the medium portion, heating efficiency can be significantly improved, and as a result, a flavor of the aerosol-generating article can be enhanced. Further, since an induction heating-type aerosol generation device used along with the induction heating-type aerosol-generating article does not need a separate susceptor element, design complexity can be reduced. Moreover, due to an improvement in the heating efficiency, a preheating time of the induction heating-type aerosol generation device can be shortened, and power consumption thereof can also be significantly reduced.

Also, the susceptor element can be disposed to form a closed loop and surround at least a portion of the medium portion. In this case, since an induced current generated in the susceptor element due to induction heating can smoothly flow along the closed loop formed in the susceptor element, the heating efficiency of the susceptor element can be further improved. For example, a heating value of the susceptor element relative to electric energy applied to an inductor can be significantly improved.

Also, the susceptor element can be made of a nonferrous metal material. Since a nonferrous metal is a material with a greater Joule heat than a ferrous metal or the like, a heating value can be increased during induction heating.

Also, since an inner wrapper is disposed between the susceptor element and the medium portion, carbonization of an outer boundary of the medium portion can be prevented.

Also, the susceptor element can be disposed in a form wrapping around the medium portion except for a downstream portion (e.g., a downstream end portion) thereof. In this case, an unheated region can be formed in the downstream portion of the medium portion to generate an aerosol filtering effect during smoking. In this way, a unique flavor can be provided to the user.

In addition, the upstream and downstream portions of the medium portion can be heated to different temperatures using a plurality of susceptor elements. For example, the downstream portion of the medium portion can be heated to a higher temperature than the upstream portion. In this case, a taste of tobacco smoke at an early stage of smoking can be improved, and a preheating time of the device can be shortened.

The advantageous effects according to the technical spirit of the present disclosure are not limited to the above-mentioned advantageous effects, and other unmentioned advantageous effects should be clearly understood by those of ordinary skill in the art from the description below.

### DESCRIPTION OF DRAWINGS

FIGS. 1 to 3 illustrate various types of aerosol generation devices that may be used along with an induction heating-type aerosol-generating article according to some embodiments of the present disclosure.

FIGS. 4 and 5 are exemplary views for describing an induction heating-type aerosol-generating article according to a first embodiment of the present disclosure.

FIG. 6 is an exemplary view for describing an induction heating-type aerosol-generating article according to a second embodiment of the present disclosure.

FIG. 7 is an exemplary view for describing an induction heating-type aerosol-generating article according to a third embodiment of the present disclosure.

FIGS. 8 to 10 are exemplary view for describing an induction heating-type aerosol-generating article according to a fourth embodiment of the present disclosure.

FIG. 11 is an exemplary view for describing an induction heating-type aerosol-generating article according to a fifth embodiment of the present disclosure.

### MODES OF THE INVENTION

Hereinafter, preferred embodiments of the present disclosure will be described in detail with reference to the accompanying drawings. Advantages and features of the present disclosure and methods of achieving the same should become clear with embodiments described in detail below with reference to the accompanying drawings. However, the technical spirit of the present disclosure is not limited to the following embodiments and may be implemented in various different forms. The embodiments make the technical spirit of the present disclosure complete and are provided to completely inform those of ordinary skill in the art to which the present disclosure pertains of the scope of the present disclosure. The technical spirit of the present disclosure is defined only by the scope of the claims.

In assigning reference numerals to components of each drawing, it should be noted that the same reference numerals are assigned to the same components as much as possible even when the components are illustrated in different drawings. Also, in describing the present disclosure, when detailed description of a known related configuration or function is deemed as having the possibility of obscuring the gist of the present disclosure, the detailed description thereof will be omitted.

Unless otherwise defined, all terms including technical or scientific terms used herein have the same meaning as commonly understood by those of ordinary skill in the art to which the present disclosure pertains. Terms defined in commonly used dictionaries should not be construed in an idealized or overly formal sense unless expressly so defined herein. Terms used in the following embodiments are for describing the embodiments and are not intended to limit the present disclosure. In the following embodiments, a singular expression includes a plural expression unless the context clearly indicates otherwise.

Also, in describing components of the present disclosure, terms such as first, second, A, B, (a), and (b) may be used. Such terms are only used for distinguishing one component from another component, and the essence, order, sequence, or the like of the corresponding component is not limited by the terms. In a case in which a certain component is described as being “connected,” “coupled,” or “linked” to another component, it should be understood that, although the component may be directly connected or linked to the other component, still another component may also be “connected,” “coupled,” or “linked” between the two components.

The terms “comprises” and/or “comprising” used herein do not preclude the presence or addition of one or more components, steps, operations, and/or devices other than those mentioned.

Some terms used in various embodiments of the present disclosure will be clarified prior to description thereof.

In the following embodiments, “aerosol-forming substrate” may refer to a material that is able to form an aerosol. The aerosol may include a volatile compound. The aerosol-forming substrate may be a solid or liquid. For example, solid aerosol-forming substrates may include solid materials based on tobacco raw materials such as reconstituted tobacco leaves, shredded tobacco, and reconstituted tobacco, and liquid aerosol-forming substrates may include liquid compositions based on nicotine, tobacco extracts, humectants, and/or various flavoring agents. However, the scope of the present disclosure is not limited to the above-listed examples. In the following embodiments, “liquid” may refer to a liquid aerosol-forming substrate.

In the following embodiments, “aerosol-generating article” may refer to an article that is able to generate an aerosol. The aerosol-generating article may include an aerosol-forming substrate. A typical example of the aerosol-generating article may include a cigarette, but the scope of the present disclosure is not limited to such an example.

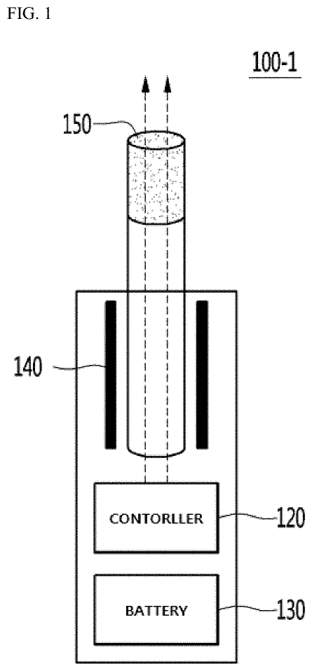

In the following embodiments, “aerosol generation device” may refer to a device that generates an aerosol using an aerosol-forming substrate in order to generate an aerosol that can be inhaled directly into the user's lungs through the user's mouth. Refer to FIGS. 1 to 3 for various examples of the aerosol generation device. However, since the types of aerosol generation devices may be more diverse, the scope of the present disclosure is not limited to such examples.

In the following embodiments, “puff” refers to inhalation by a user, and the inhalation may refer to a situation in which a user draws smoke into his or her oral cavity, nasal cavity, or lungs through the mouth or nose.

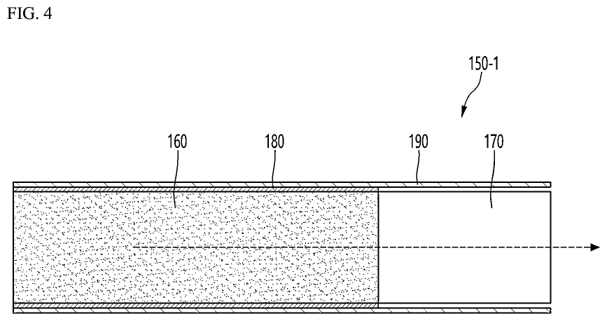

In the following embodiments, “upstream” or “upstream direction” may refer to a direction moving away from an oral region of a user, and “downstream” or “downstream direction” may refer to a direction approaching the oral region of the user. The terms “upstream” and “downstream” may be used to describe relative positions of elements constituting an aerosol-generating article. For example, in an aerosol-generating article (e.g., 150-1) illustrated in FIG. 4 or the like, a filter portion 170 is disposed downstream of or in a downstream direction from a medium portion 160, and the medium portion 160 is disposed upstream of or in an upstream direction from the filter portion 170.

Hereinafter, various embodiments of the present disclosure will be described in detail with reference to the accompanying drawings.

FIGS. 1 to 3 illustrate various types of induction heating-type aerosol generation devices 100-1 to 100-3 that may be used along with an induction heating-type aerosol-generating article 150 according to some embodiments of the present disclosure. Hereinafter, in describing the induction heating-type aerosol-generating article 150 and the induction heating-type aerosol generation devices 100-1 to 100-3, for convenience of description, the term “induction heating-type” will be omitted. Hereinafter, the aerosol generation devices 100-1 to 100-3 will be described.

First, as illustrated in FIG. 1, the aerosol generation device 100-1 may include a housing, a heater portion 140, a controller 120, and a battery 130. However, only the components relating to the embodiment of the present disclosure are illustrated in FIG. 1. Therefore, those of ordinary skill in the art to which the present disclosure pertains should understand that the aerosol generation device 100-1 may further include general-purpose components other than the components illustrated in FIG. 1. For example, the aerosol generation device 100-1 may further include an output module (e.g., a motor, a display) for outputting an indication of a state of the device and/or an input module (e.g., a button) for receiving a user input (e.g., to turn on or off the device). Hereinafter, each component of the aerosol generation device 100-1 will be described.

The housing may form an exterior of the aerosol generation device 100-1. Also, the housing may form an accommodation space for accommodating the aerosol-generating article 150. The aerosol-generating article 150 accommodated in the accommodation space may generate an aerosol due to being heated by the heater portion 140, and the generated aerosol may be inhaled by a user through the oral region of the user.

Next, the heater portion 140 may heat the aerosol-generating article 150 accommodated in the accommodation space to generate an aerosol. More specifically, the heater portion 140 may include an inductor for inductively heating a susceptor element. Examples of the inductor may include an induction coil, but the scope of the present disclosure is not limited thereto. The susceptor element may be embedded in the aerosol-generating article 150. In this case, since the susceptor element is not required to be included in the heater portion 140, the structure of the heater portion 140 may be simplified. Also, as a result, design complexity of the aerosol generation device 100-1 may be reduced, the weight and size of the aerosol generation device 100-1 may be reduced, and a defect occurrence rate may also be reduced during manufacture. Further, since heat generated in the susceptor element due to induction heating may be directly transmitted to the aerosol-generating article 150, heating efficiency may be significantly improved.

In some embodiments, the susceptor element may be wrapped around a medium portion of the aerosol-generating article 150. In other words, a wrapper related to the medium portion may serve as a susceptor and heat the medium portion. In this case, as mentioned above, since heat generated in the susceptor element may be directly transmitted to an outer boundary of the medium portion, heating efficiency may be significantly improved. Various examples of the aerosol-generating article 150 will be described in detail below with reference to FIG. 4 and so on.

However, in some other embodiments, the heater portion 140 may include a susceptor element for heating the aerosol-generating article 150.

Next, the controller 120 may control the overall operation of the aerosol generation device 100-1. For example, the controller 120 may control the operation of the heater portion 140 and the battery 130 and also control the operation of other components included in the aerosol generation device 100-1. The controller 120 may control the power supplied by the battery 130, a heating temperature of the heater portion 140, and the like. Also, the controller 120 may check a state of each of the components of the aerosol generation device 100-1 and determine whether the aerosol generation device 100-1 is in an operable state.

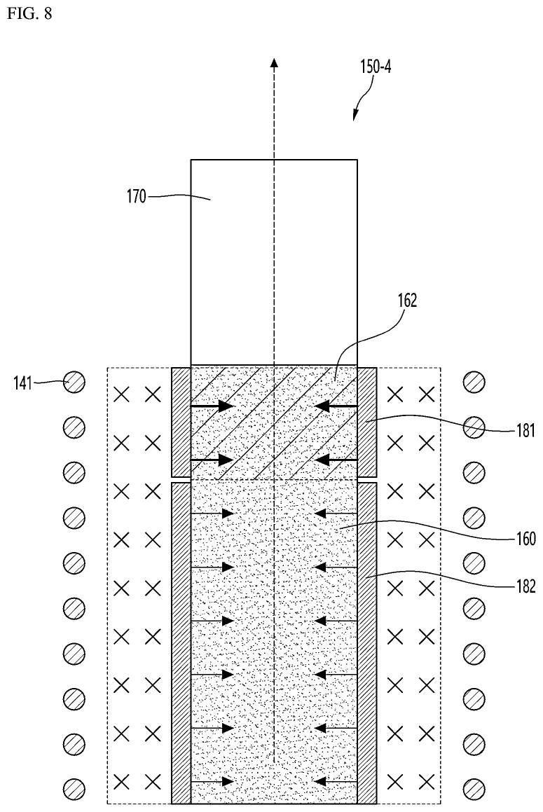

In some embodiments, the controller 120 may control an induction heating frequency applied to the inductor constituting the heater portion 140. A frequency of the induced current generated in the susceptor element may vary according to the induction heating frequency applied to the inductor, and the current penetration depth and the heating performance of the susceptor element may vary according to the frequency of the induced current. Therefore, the controller 120 may control the heating performance of the susceptor element through the induction heating frequency. This will be described in detail below with reference to FIGS. 8 to 10, along with an example of the aerosol-generating article 150.

The controller 120 may be implemented with at least one processor. The processor may also be implemented with an array of a plurality of logic gates or implemented with a combination of a general-purpose microprocessor and a memory which stores a program that may be executed by the microprocessor. Also, those of ordinary skill in the art to which the present disclosure pertains should clearly understand that the controller 120 may also be implemented with other forms of hardware.

Next, the battery 130 may supply the power used to operate the aerosol generation device 100-1. For example, the battery 130 may supply power to the heater portion 140 and may also supply power required to operate the controller 120.

Also, the battery 130 may supply power required to operate electrical components such as a display (not illustrated), a sensor (not illustrated), and a motor (not illustrated) which are installed in the aerosol generation device 100-1.

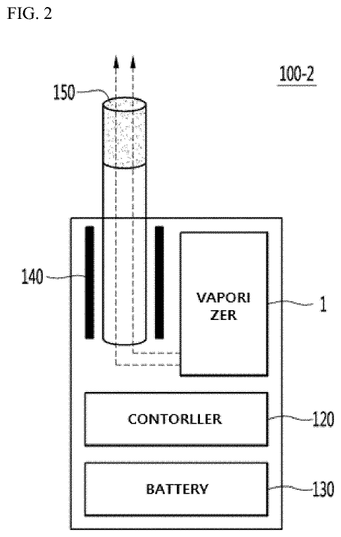

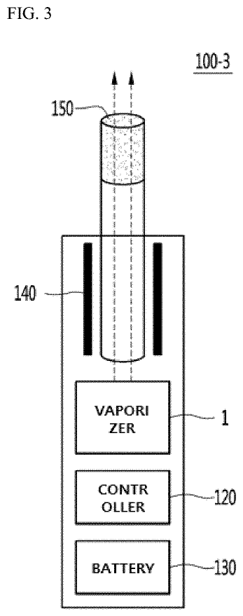

Hereinafter, other types of aerosol generation devices 100-2 and 100-3 will be described with reference to FIGS. 2 and 3.

FIGS. 2 and 3 are exemplary views schematically illustrating hybrid-type aerosol generation devices 100-2 and 100-3 in which the aerosol-generating article 150 and a liquid aerosol-forming substrate are used together. Specifically, FIG. 2 illustrates the device 100-2 in which a vaporizer 1 and the aerosol-generating article 150 are arranged in parallel, and FIG. 3 illustrates the device 100-3 in which the vaporizer 1 and the aerosol-generating article 150 are arranged in series. However, the scope of the present disclosure is not limited to such examples, and the arrangement form inside aerosol generation devices (e.g., 100-1 to 100-3) may be modified in various ways.

As illustrated in FIG. 2 or 3, the aerosol generation devices 100-2 and 100-3 may further include the vaporizer 1. However, this is only a preferred embodiment for achieving the objectives of the present disclosure, and, of course, some components may be added or omitted as necessary. Hereinafter, each component of the aerosol generation devices 100-2 and 100-3 will be described. However, for clarity of the present disclosure, description of contents overlapping with those relating to the aerosol generation device 100-1 described above will be omitted.

The vaporizer 1 may vaporize a liquid aerosol-forming substrate to generate an aerosol. For example, the vaporizer 1 may be configured to include a liquid reservoir which stores the liquid aerosol-forming substrate, a wick which absorbs the stored liquid, and a liquid vaporizing element which vaporizes the absorbed liquid. Here, the liquid vaporizing element may be implemented as a heating element, implemented as a vibrating element which vaporizes a liquid through ultrasonic vibrations, or implemented in other forms. Also, the scope of the present disclosure is not limited to such examples. In addition, the vaporizer 1 may be implemented to have a different structure. For example, the vaporizer 1 may be implemented to have a structure that does not include a wick.

The aerosol generated in the vaporizer 1 may pass through the aerosol-generating article 150 and be inhaled by the user through the oral region of the user. The liquid vaporizing element of the vaporizer 1 may be controlled by the controller 120.

Refer to the above descriptions relating to FIG. 1 for the descriptions of the heater portion 140, the battery 130, and the controller 120.

Various types of aerosol generation devices 100-1 to 100-3 that may be used along with the aerosol-generating article 150 according to some embodiments of the present disclosure have been described above with reference to FIGS. 1 to 3. Hereinafter, various examples of the aerosol-generating article 150 will be described in detail with reference to FIG. 4 and so on.

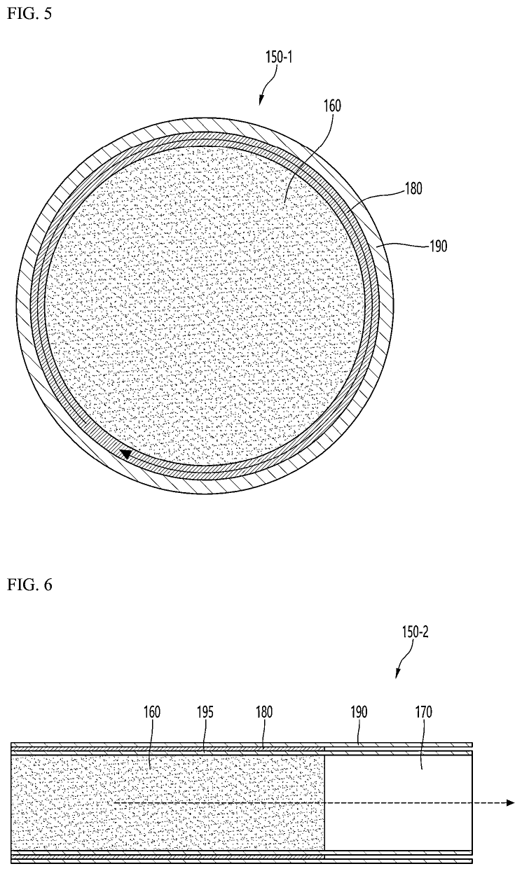

FIGS. 4 and 5 are views for describing an aerosol-generating article 150-1 according to a first embodiment of the present disclosure. Specifically, FIG. 4 illustrates a schematic cross-sectional view of the aerosol-generating article 150-1 in the longitudinal direction thereof, and FIG. 5 illustrates a schematic cross-sectional view relating to an end of the medium portion 160. In FIG. 4 and so on, dotted direction arrows indicate transfer of an aerosol.

As illustrated in FIG. 4, the aerosol-generating article 150-1 may include the filter portion 170, the medium portion 160, a susceptor element 180, and an outer wrapper 190. However, only the components relating to the embodiment of the present disclosure are illustrated in FIG. 4. Therefore, those of ordinary skill in the art to which the present disclosure pertains should understand that the aerosol-generating article 150-1 may further include general-purpose components other than the components illustrated in FIG. 4. Hereinafter, each component of the aerosol-generating article 150-1 will be described.

The filter portion 170 may be connected to a downstream end of the medium portion 160 and serve to filter an aerosol generated in the medium portion 160. For example, the filter portion 170 and the medium portion 160 may have a cylindrical shape and aligned in a longitudinal axis direction, and an upstream end of the filter portion 170 may be connected to the downstream end of the medium portion 160. The filter portion 170 and the medium portion 160 may be connected by a tipping wrapper, but the scope of the present disclosure is not limited thereto. The aerosol that has passed through the filter portion 170 may be inhaled by the user through the oral region of the user. Here, a downstream end of the filter portion 170 may also serve as a mouthpiece (portion) that comes in contact with the user's lips.

The filter portion 170 may include a filter material having a function of filtering an aerosol. Also, the filter portion 170 may further include a filter wrapper which wraps around the filter material. Examples of the filter material may include cellulose acetate fibers (tow), a cellulose material (e.g., paper), activated carbon, and the like, but the scope of the present disclosure is not limited thereto. Also, at least one capsule (not illustrated) may be included in the filter portion 170. For example, the capsule may be a spherical or cylindrical capsule in which a flavoring liquid is wrapped by a film.

The filter portion 170 may have a single filter structure or a multi-filter structure. Also, the filter portion 170 may include a cavity formed between the plurality of filter portions. In some embodiments, the downstream end of the filter portion 170 may be manufactured as a recessed filter. The filter portion 170 may also include a cooling portion which performs a function of cooling an aerosol. In this way, a detailed structure of the filter portion 170 may be modified in various ways.

Next, the medium portion 160 may be disposed upstream of the filter portion 170 and connected to the upstream end of the filter portion 170. The medium portion 160 may generate an aerosol due to being heated by the susceptor element 180.

The medium portion 160 may include an aerosol-forming substrate. Also, the medium portion 160 may further include a wrapper which wraps around the aerosol-forming substrate. For example, the aerosol-forming substrate may include a tobacco material. Also, the aerosol-forming substrate may further include another material. For example, the aerosol-forming substrate may further include at least one of glycerin, propylene glycol, ethylene glycol, dipropylene glycol, diethylene glycol, triethylene glycol, tetraethylene glycol, and oleyl alcohol. However, the aerosol-forming substrate is not limited thereto. Also, the aerosol-forming substrate may contain other additives such as a flavoring agent, a wetting agent (that is, a moisturizing material), and/or organic acid. Also, a flavoring liquid such as a menthol flavoring liquid may be added into the aerosol-forming substrate.

Next, the susceptor element 180 is an element heating the medium portion 160 due to being inductively heated by the inductor and may be disposed to wrap around at least a portion of the medium portion 160. For example, as illustrated, the susceptor element 180 may be disposed to wrap around the entire medium portion 160. In this case, heating may be uniformly performed throughout the medium portion 160, and due to a maximized heating area, the medium portion 160 may be promptly heated. As another example, the susceptor element 180 may also be disposed to wrap around a portion (e.g., an upstream portion) of the medium portion 160.

As illustrated in FIG. 5, the susceptor element 180 may form a closed loop and be disposed to wrap around the medium portion 160. For example, both ends of the susceptor element 180 may be disposed to be connected to each other (or come in contact with each other), or the susceptor element 180 may be formed in a closed loop shape (e.g., a cylindrical shape). In this case, since the induced current generated in the susceptor element 180 due to induction heating may smoothly flow along the closed loop (see the arrow in FIG. 5), the heating efficiency of the susceptor element 180 may be significantly improved. For example, since a heating value of the susceptor element 180 relative to power applied to the inductor is increased, the medium portion 160 may be effectively heated.

Since the closed loop is required to allow a smooth flow of the induced current, in a case in which a connecting portion is present at both ends of the susceptor element 180, preferably, the connecting portion may be made of a material that conducts electricity well instead of being made of an insulator.

Also, in a case in which the inductor is implemented as an induction coil, preferably, the closed loop may be formed along a winding direction of the induction coil. In this case, the induced current may easily flow through the closed loop of the susceptor element 180, and thus the heating efficiency of the susceptor element 180 may be further increased. The susceptor element 180 may be designed to have various materials, lengths, and/or thicknesses, and detailed specifications thereof may vary according to the embodiment.

In some embodiments, the susceptor element 180 may be made of an inductively-heatable nonferrous metal material. For example, the susceptor element may be made of a material such as copper and aluminum. Since nonferrous metal materials have a Joule heat of a large magnitude, a heating value of the susceptor element 180 may be increased during induction heating. However, the scope of the present disclosure is not limited thereto, and the susceptor element 180 may also be made of a ferrous metal material such as iron and stainless steel or another inductively-heatable material.

In some embodiments, a thickness of the susceptor element 180 may be in a range of about 4 μm to 50 μm. Preferably, the thickness may be in a range of about 5 μm to 40 μm, about 6 μm to 30 μm, or about 8 μm to 20 μm. Within such numerical ranges, durability of the susceptor element 180 and service life of the battery may be properly guaranteed. For example, when the thickness of the susceptor element 180 is too thin, the durability thereof may decrease, and a problem of damage to the susceptor element 180, such as tearing of the susceptor element 180 during a manufacturing process, may occur. Conversely, when the thickness of the susceptor element 180 is too thick, power consumption during induction heating may increase due to an increase in the heat capacity of the susceptor element 180, and thus the service life of the battery may be decreased. Moreover, since diameters (or thicknesses) of the medium portion 160 and the filter portion 170 become different from each other (e.g., the medium portion 160 may become thicker due to the susceptor element 180), a problem of degrading the appearance of the aerosol-generating article 150-1 may also occur.

Next, the outer wrapper 190 may refer to a wrapping material which wraps around the susceptor element 180 on the outside of the susceptor element 180. The outer wrapper 190 serves as an insulating material that blocks heat of the susceptor element 180 from being emitted to the outside, thus further improving the heating efficiency of the susceptor element 180. The outer wrapper 190 may be made of a porous or nonporous wrapping material or may be made of a paper material but is not limited thereto.

The outer wrapper 190 may correspond to an individual wrapper such as the wrapper of the medium portion 160, the filter wrapper surrounding the filter portion 170, or the tipping wrapper or may also refer to the wrapper of the aerosol-generating article 150-1 that includes all the individual wrappers.

Meanwhile, the aerosol-generating article 150-1 may be designed to have various lengths, thicknesses, diameters, and/or shapes. In some embodiments, the aerosol-generating article 150-1 may have a diameter in a range of about 4 mm to 9 mm and a length in a range of about 45 mm to 50 mm. However, the scope of the present disclosure is not limited to such examples.

The aerosol-generating article 150-1 according to the first embodiment of the present disclosure has been described above with reference to FIGS. 4 and 5. According to the above description, the susceptor element 180 may be embedded in the form of a wrapper in the aerosol-generating article 150-1. In this case, since heat generated in the susceptor element 180 due to induction heating is directly transmitted to the medium portion 160, heating efficiency may be significantly improved, and accordingly, the flavor of the aerosol-generating article 150-1 may be enhanced. Further, since the aerosol generation device (e.g., 100-1) used along with the aerosol-generating article 150-1 does not need a separate susceptor element, design complexity of the aerosol generation device (e.g., 100-1) may be reduced, and the weight and size thereof may be reduced. Moreover, due to an improvement in the heating efficiency, power consumption of the aerosol generation device (e.g., 100-1) may be significantly reduced. Also, since the susceptor element 180 is disposed to form a closed loop, the induced current generated in the susceptor element 180 may smoothly flow along the closed loop, and thus the heating efficiency of the susceptor element 180 may be further improved.

Hereinafter, an aerosol-generating article 150-2 according to a second embodiment of the present disclosure will be described with reference to FIG. 6. Hereinafter, for clarity of the present disclosure, description of contents overlapping with those of the previous embodiments will be omitted, and description will be continued focusing on differences from the previous embodiments.

FIG. 6 is a view schematically illustrating the aerosol-generating article 150-2 according to the second embodiment of the present disclosure.

As illustrated in FIG. 6, the aerosol-generating article 150-2 may further include an inner wrapper 195 disposed inside the susceptor element 180.

The inner wrapper 195 may be disposed to wrap around the medium portion 160 or at least a portion of the aerosol-generating article 150-2 on the inside of the susceptor element 180 to prevent carbonization of a surface portion of the medium portion 160. For example, the inner wrapper 195 may prevent the susceptor element 180 from coming in close contact with an outer surface of the medium portion 160 and directly transmitting heat thereto, thus effectively preventing the surface portion of the medium portion 160 from being carbonized. The inner wrapper 195 may be made of a porous or nonporous wrapping material or may be made of a paper material but is not limited thereto.

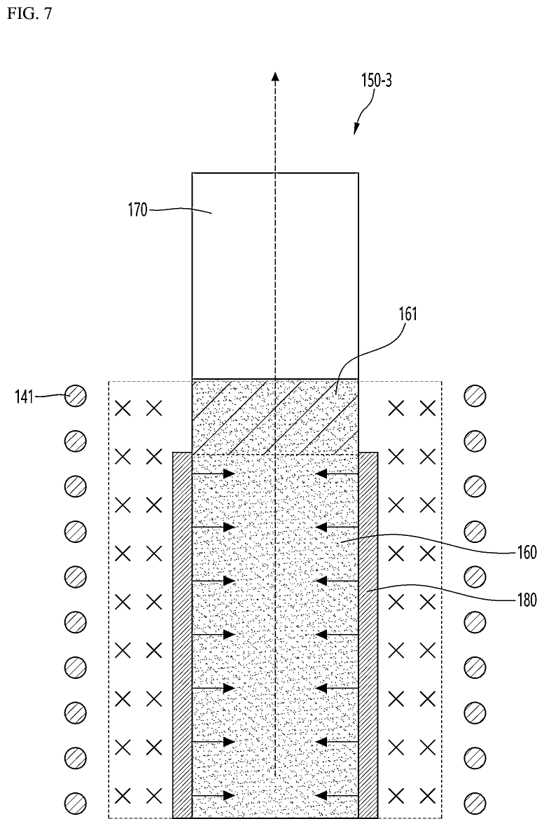

The aerosol-generating article 150-2 according to the second embodiment of the present disclosure has been described above with reference to FIG. 6. Hereinafter, an aerosol-generating article 150-3 according to a third embodiment of the present disclosure will be described with reference to FIG. 7.

FIG. 7 is a view for describing the aerosol-generating article 150-3 according to the third embodiment of the present disclosure. In FIG. 7 and so on, a region marked with “X” conceptually show a magnetic field region formed around the aerosol-generating article (e.g., 150-3), and linear arrows conceptually show heat transfer. Also, in FIG. 7 and so on, illustration of the other wrappers (e.g., 190, 195) in addition to the susceptor element 180 has been omitted for convenience of understanding.

As illustrated in FIG. 7, in the present embodiment, the susceptor element 180 may form a closed loop and be disposed to wrap around the medium portion 160 except for a downstream portion 161 (e.g., a downstream end portion) thereof. In this case, as the susceptor element 180 is inductively heated by an inductor 141, only an upstream portion of the medium portion 160 may be heated, and an unheated region may be formed in the downstream portion 161.

The unheated region 161 may lower the temperature in the vicinity of the downstream portion (e.g., the downstream end portion) of the medium portion 160 to improve an effect of filtering a generated aerosol. Here, “filtering” may not only refer to a case in which some components included in an aerosol are filtered, but also refer to a case in which other components are added into the aerosol. That is, “filtering” may be understood as encompassing all the cases in which a change occurs in the components of the aerosol.

More specifically, as an aerosol passes through the unheated region 161, some components in the aerosol may be filtered, or some components included in the unheated region 161 may be added into the aerosol. Therefore, components of the aerosol discharged to the outside of the aerosol-generating article 150-3 may be different from components of the initially-generated aerosol, and in this way, a different flavor may be generated as compared to when the entire medium portion 160 is heated.

The aerosol-generating article 150-3 according to the third embodiment of the present disclosure has been described above with reference to FIG. 7. According to the above description, since the susceptor element 180 is disposed so that an unheated region is formed in the downstream portion 161 of the medium portion 160, an aerosol filtering effect may be improved, and in this way, a unique flavor may be provided to the user.

Hereinafter, an aerosol-generating article 150-4 according to a fourth embodiment of the present disclosure will be described with reference to FIGS. 8 to 10.

FIG. 8 is a view for describing the aerosol-generating article 150-4 according to the fourth embodiment of the present disclosure.

As illustrated in FIG. 8, in the present embodiment, a plurality of susceptor elements 181 and 182 may be disposed to wrap around the medium portion 160. Specifically, the first susceptor element 181 may be disposed to wrap around a downstream portion 162 of the medium portion 160, and the second susceptor element 182 may be disposed to wrap around an upstream portion of the medium portion 160. FIG. 8 illustrates an example in which the two susceptor elements 181 and 182 are disposed, but this is only for providing convenience of understanding, and the number of susceptor elements may also be three or more.

As illustrated, by the first susceptor element 181 heating the downstream portion 162 of the medium portion 160 to a temperature higher than a heating temperature of the second susceptor element 182 (that is, by heating the downstream portion 162 more than the upstream portion), an intensive heating region may be formed in the downstream portion 162. In this case, since an aerosol may be smoothly generated from an early stage of smoking, a flavor and a tobacco smoke taste at the early stage of smoking may be enhanced. Further, since the downstream portion 162 which affects the tobacco smoke taste at the early stage of smoking is heated rapidly, a preheating time of the aerosol generation device (e.g., 100-1) may also be shortened.

Increasing a heating temperature (or a heating value) of the first susceptor element 181 to be higher than that of the second susceptor element 182 may be implemented using various methods, and a specific method may vary according to the embodiment.

In some embodiments, a difference in the heating temperature may be generated through a difference between materials of the first susceptor element 181 and the second susceptor element 182. For example, the first susceptor element 181 may be made of a material which generates a Joule heat having a first magnitude, and the second susceptor element 182 may be made of a material which generates a Joule heat having a second magnitude smaller than the first magnitude. For example, the first susceptor element 181 may be made of a nonferrous metal material, and the second susceptor element 182 may be made of a ferrous metal material. In this case, due to a difference in the Joule heat of the materials, the downstream portion 162 of the medium portion 160 may be heated to a higher temperature than the upstream portion. For example, even when an induction heating frequency (e.g., a frequency of an applied alternating current or voltage) which is applied to the inductor 141 by the controller 120 is the same for the two susceptor elements 181 and 182, due to the difference in the Joule heat of the materials, the downstream portion 162 may be heated to a higher temperature than the upstream portion.

In some other embodiments, a difference in the heating temperature may be generated through wrapping forms of the first susceptor element 181 and the second susceptor element 182. For example, the first susceptor element 181 may form a closed loop and wrap around the downstream portion 162 of the medium portion 160, and the second susceptor element 182 may wrap around the upstream portion of the medium portion 160 but may not form a closed loop. In this case, due to the heating efficiency of the first susceptor element 181, the heating temperature of the first susceptor element 181 may become higher than that of the second susceptor element 182 even when the same power is applied.

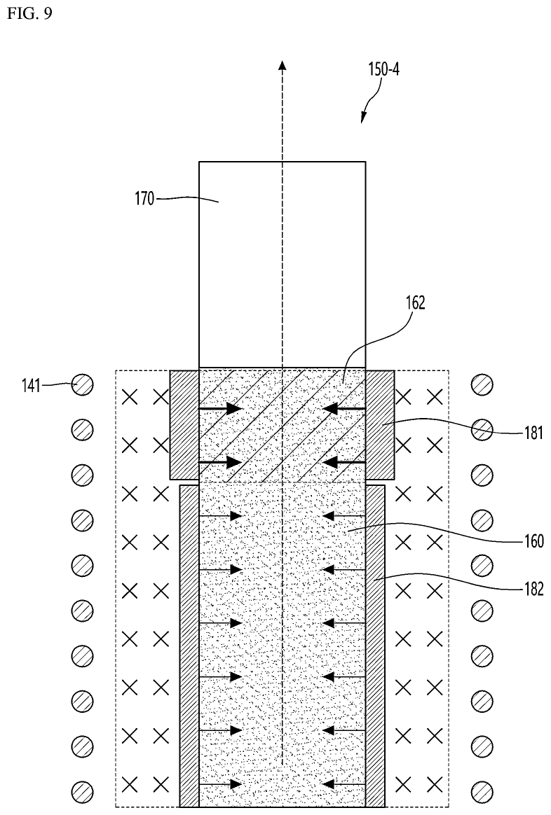

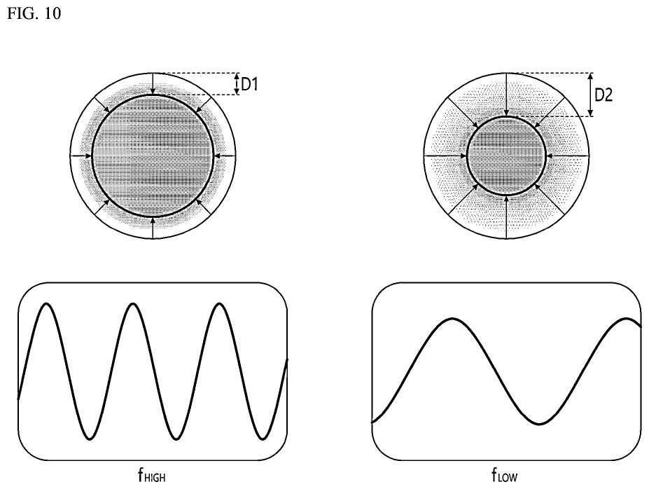

In still some other embodiments, a difference in the heating temperature may be generated through a difference in thickness between the first susceptor element 181 and the second susceptor element 182. For example, as illustrated in FIG. 9, it is assumed that the thickness of the first susceptor element 181 is greater than that of the second susceptor element 182. In this case, when the controller 120 applies an induction heating frequency suitable for the first susceptor element 181 to the inductor 141, the first susceptor element 181 may generate heat at a higher temperature than the second susceptor element. This is a phenomenon occurring due to a frequency of the induced current generated in the susceptor elements 181 and 182 and the current penetration depth caused thereby. This will be further described below with reference to FIG. 10 in order to provide better understanding.

As illustrated in FIG. 10, the higher the frequency of the induced current generated in the susceptor elements (e.g., 181, 182), the shallower the current penetration depth (see f_{HIGH} and D1). Also, the lower the frequency, the deeper the current penetration depth (see f_{LOW} and D2). Therefore, it may be preferable to generate an induced current having a high frequency when the susceptor elements (e.g., 181, 182) have a small thickness and generate an induced current having a low frequency in the opposite case. This is because, when an induced current having a high frequency is generated when the susceptor elements (e.g., 181, 182) have a large thickness, heat may only be generated on a surface and thus a heating value may not be high. For reference, since a frequency of the induced current generated in the susceptor elements (e.g., 181, 182) is determined by an induction heating frequency applied to the inductor 141, the controller 120 may control the frequency of the induced current through the induction heating frequency.

The above-described embodiment will be further described by referring back to FIG. 9. When the controller 120 applies an induction heating frequency suitable for the first susceptor element 181 (e.g., a low frequency) to the inductor 141, heat may be generated across the thickness of the first susceptor element 181, and thus a heating value of the first susceptor element 181 may become higher than that of the second susceptor element 182, and the downstream portion 162 of the medium portion 160 may be heated more than the upstream portion. Conversely, when the controller 120 applies an induction heating frequency suitable for the second susceptor element 182 (e.g., a high frequency) to the inductor 141, heat may be generated only on a surface of the first susceptor element 181, and thus the heating value of the second susceptor element 182 may become higher than that of the first susceptor element 181, and the downstream portion 162 of the medium portion 160 may be heated less than the upstream portion. In this case, as described above, the aerosol filtering effect may be improved. In either case, since the same induction heating frequency is applied to the inductor 141 which inductively heats the first susceptor element 181 and the second susceptor element 182, there is an advantage in that the controller 120 does not need a plurality of inductors 141 or oscillators.

In yet some other embodiments, a difference in the heating temperature may be generated through an induction heating frequency applied to each of a first inductor which inductively heats the first susceptor element 181 and a second inductor which inductively heats the second susceptor element 182. For example, the controller 120 may apply an induction heating frequency suitable for the first susceptor element 181 (e.g., a frequency that can generate an induced current whose current penetration depth is similar to the thickness of the first susceptor element 181) to the first inductor and may apply an induction heating frequency not suitable for the second susceptor element 182 to the second inductor. Here, the first susceptor element 181 and the second susceptor element 182 may have the same thickness or different thicknesses. As a more specific example, when the first susceptor element 181 and the second susceptor element 182 have the same thickness, the controller 120 may apply a first induction heating frequency suitable for the first susceptor element 181 to the first inductor and may apply a second induction heating frequency different from the first induction heating frequency to the second inductor. In this case, due to a difference between the induction heating frequencies, the first susceptor element 181 may be heated to a higher temperature than the second susceptor element 182.

In yet some other embodiments, a difference in the heating temperature may occur between the first susceptor element 181 and the second susceptor element 182 due to a combination of the above-described embodiments.

The aerosol-generating article 150-4 according to the fourth embodiment of the present disclosure has been described above with reference to FIGS. 8 to 10. According to the above description, using the plurality of susceptor elements 181 and 182, the downstream portion 162 of the medium portion 160 may be heated more than the upstream portion. In this case, a tobacco smoke taste at an early stage of smoking may be enhanced, and a preheating time of the aerosol generation devices (e.g., 100-1 to 100-3) may be shortened.

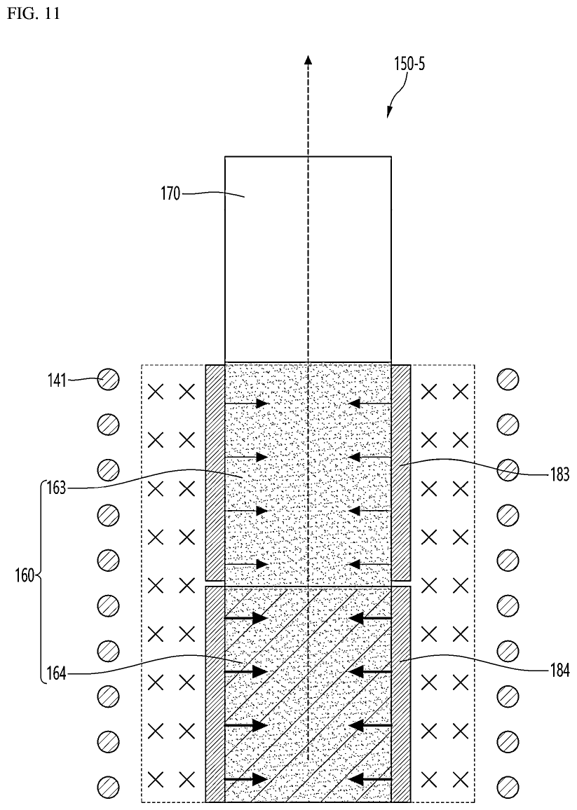

Hereinafter, an aerosol-generating article 150-5 according to a fifth embodiment of the present disclosure will be described with reference to FIG. 11.

FIG. 11 is a view for describing the aerosol-generating article 150-5 according to the fifth embodiment of the present disclosure.

As illustrated in FIG. 11, in the present embodiment, the medium portion 160 may consist of a plurality of segments 163 and 164, and a plurality of susceptor elements 183 and 184 may be disposed to independently heat each of the segments 163 and 164. FIG. 11 illustrates an example in which the medium portion 160 consists of the two segments 163 and 164, but this is only for providing convenience of understanding, and the medium portion 160 may also consist of three or more segments. Likewise, the number of susceptor elements may also be three or more. The number of susceptor elements may not be equal to the number of segments (e.g., a case in which a single susceptor element heats a plurality of segments).

Specifically, the first segment 163 disposed downstream of the second segment 164 may include a tobacco material containing nicotine. Also, the second segment 164 disposed upstream of the first segment 163 may include a moisturizing material without a tobacco material. Examples of the moisturizing material may include glycerin and propylene glycol, but the scope of the present disclosure is not limited to such examples.

The second susceptor element 184 disposed to heat the second segment 164 may heat the second segment 164 to a temperature higher than a heating temperature of the first susceptor element 183. In this case, since an intensive heating region is formed in the second segment 164, a high-temperature aerosol may be smoothly formed from the moisturizing material. Also, since the high-temperature aerosol may easily absorb the nicotine component while passing through the first segment 163, the aerosol discharged through the aerosol-generating article 150-5 may contain a large amount of nicotine component, and thus a tobacco smoke taste felt by the user may be enhanced.

Refer to the description of the previous embodiments for methods of increasing a heating temperature of the second susceptor element 184 to be higher than that of the first susceptor element 183.

The aerosol-generating article 150-5 according to the fifth embodiment of the present disclosure has been described above with reference to FIG. 11. According to the above description, since the moisturizing material and the tobacco material are located in different segments in the medium portion 160 and the segment 164 including the moisturizing material is designed to be heated more, the aerosol may contain a large amount of nicotine component. Accordingly, a tobacco smoke taste felt by the user may be enhanced.

The aerosol-generating articles 150-1 to 150-5 according to the first to fifth embodiments of the present disclosure have been described above with reference to FIGS. 4 to 11. Although the first to fifth embodiments have been described separately for better understanding, the embodiments may be combined in various forms. For example, the aerosol-generating article 150-3 according to the third embodiment may further include the inner wrapper 195. As another example, the susceptor element 180 of the aerosol-generating article 150-3 may consist of a plurality of susceptor elements, and each susceptor element may be designed to heat each portion of the medium portion 160 to different temperatures. As still another example, the first susceptor element 181 of the aerosol-generating article 150-4 according to the fourth embodiment may be disposed to wrap around the downstream portion of the medium portion 160 except for an end portion thereof.

The embodiments of the present disclosure have been described above with reference to the accompanying drawings, but those of ordinary skill in the art to which the present disclosure pertains should understand that the present disclosure may be embodied in other specific forms without changing the technical spirit or essential features thereof. Therefore, the embodiments described above should be understood as being illustrative, instead of limiting, in all aspects. The scope of the present disclosure should be interpreted by the claims below, and any technical spirit within the scope equivalent to the claims should be interpreted as falling within the scope of the technical spirit defined by the present disclosure.

What is claimed is:

1. An induction heating-type aerosol-generating article comprising:
a medium portion which includes an aerosol-forming substrate;
a susceptor element which forms a closed loop to wrap around at least a portion of the medium portion and which is configured to, due to induction heating being performed therein, heat the portion of the medium portion; and
an outer wrapper which wraps around at least a portion of the susceptor element.

2. The induction heating-type aerosol-generating article of claim 1, wherein the susceptor element is made of an inductively-heatable nonferrous metal material.

3. The induction heating-type aerosol-generating article of claim 1, further comprising an inner wrapper which is disposed between the susceptor element and the medium portion to wrap around the portion of the medium portion.

4. The induction heating-type aerosol-generating article of claim 1, wherein a thickness of the susceptor element is in a range of 6 μm to 30 μm.

5. The induction heating-type aerosol-generating article of claim 1, wherein the susceptor element is configured to wrap around an upstream portion of the medium portion such that an unheated region is formed in a downstream portion of the medium portion when the induction heating is performed.

6. The induction heating-type aerosol-generating article of claim 1, wherein the susceptor element includes a first susceptor element which wraps around a downstream portion of the medium portion and a second susceptor element which wraps around an upstream portion of the medium portion, such that the downstream portion is heated to a higher temperature than the upstream portion by the first susceptor element when the induction heating is performed.

7. The induction heating-type aerosol-generating article of claim 1, wherein:
the medium portion includes a first segment which contains a tobacco material and a second segment which is disposed upstream of the first segment and contains a moisturizing material; and
the susceptor element includes a first susceptor element which wraps around the first segment and a second susceptor element which wraps around the second segment, such that the second segment is heated to a higher temperature than the first segment by the second susceptor element when the induction heating is performed.

8. An induction heating-type aerosol generation device comprising:
a housing which forms an accommodation space for accommodating an aerosol-generating article; and
an inductor which inductively heats the aerosol-generating article accommodated in the accommodation space to generate an aerosol,
wherein the aerosol-generating article includes a medium portion which includes an aerosol-forming substrate and a susceptor element which forms a closed loop to wrap around at least a portion of the medium portion, such that the aerosol is generated as the susceptor element is inductively heated by the inductor.

9. The induction heating-type aerosol generation device of claim 8, wherein the induction heating-type aerosol generation device does not include the susceptor element inductively heated by the inductor.

10. The induction heating-type aerosol generation device of claim 8, further comprising a controller which controls an induction heating frequency applied to the inductor,
wherein the susceptor element includes a first susceptor element which wraps around a downstream portion of the medium portion and a second susceptor element which wraps around an upstream portion of the medium portion,
the inductor inductively heats the first susceptor element and the second susceptor element using the same induction heating frequency, and
the first susceptor element has a thickness different from a thickness of the second susceptor element.

11. The induction heating-type aerosol generation device of claim 8, further comprising a controller which controls an induction heating frequency applied to the inductor,
wherein the susceptor element includes a first susceptor element which wraps around a downstream portion of the medium portion and a second susceptor element which wraps around an upstream portion of the medium portion,
the inductor inductively heats the first susceptor element and the second susceptor element using a same induction heating frequency, and
the first susceptor element is made of a material different from a material of the second susceptor element.

12. The induction heating-type aerosol generation device of claim 8, further comprising a controller which controls an induction heating frequency applied to the inductor,
wherein the susceptor element includes a first susceptor element which wraps around a downstream portion of the medium portion and a second susceptor element which wraps around an upstream portion of the medium portion, and
the inductor includes a first inductor which inductively heats the first susceptor element using a first induction heating frequency and a second inductor which inductively heats the second susceptor element using a second induction heating frequency different from the first induction heating frequency.

13. The induction heating-type aerosol generation device of claim 12, wherein a thickness of the first susceptor element is equal to a thickness of the second susceptor element.
